(19) United States
(12) Patent Application Publication
(10) Pub. No.: US 2014/0347974 A1
(43) Pub. Date: Nov. 27, 2014

(54) DATA TRANSMISSION NETWORK AND PROGRAMMABLE NETWORK NODE

(71) Applicants: Thales, Neuilly Sur Seine (FR); Systemes Embarques Aerospatiaux, Paris (FR)

(72) Inventors: Alexis Dubrovin, Meudon La Foret (FR); Augustin Mignot, Meudon La Foret (FR); Paul Ortais, Meudon La Foret (FR)

(21) Appl. No.: 14/359,489

(22) PCT Filed: Nov. 19, 2012
(86) PCT No.: PCT/EP2012/073001

§ 371 Date: Aug. 15, 2014

(30) Foreign Application Priority Data
Nov. 22, 2011 (FR) 11/03548

(51) Int. Cl. H04L 12/24; H04L 12/863; H04L 12/43

(52) U.S. Cl. CPC H04L 41/0836; H04L 12/43; H04L 41/0672; H04L 47/6245
USPC 370/216; 370/412

(57) ABSTRACT

The network including functional nodes (10) connected in series by a data transmitter (11; 12), in which the data assumes the form of discrete messages propagating from node to node in the network, is characterized in that the a data transmitter (11; 12) between the nodes are bidirectional to allow data to propagate in both circulation directions of the network, and each node (10) includes at least one first and one second port associated by programming, for data input/output (13, 14), connected to adjacent nodes by a corresponding data transmitter (11; 12) and the operation of which is controlled exclusively and sequentially, by a communication automaton (15), between an operating mode for the asynchronous reception of data from the adjacent nodes, and an operating mode for the synchronous transmission of data to the nodes adjacent thereto.

The present invention relates to a data transmission network and a corresponding programmable network node.

More specifically, the invention relates to such a network that includes functional nodes connected in series by data transmission means, in which the data assumes the form of discrete messages propagating from node to node in the network.

### BACKGROUND

A data transmission method and device are already known from document FR-A-

2,857,805.

Such a method and such a system are for example implemented in a closed system of onboard computers, for example in an air or land vehicle.

The method described in this document includes a step for point-to-point data transmission between two transmission nodes, for example via a wired network, each node having one or more channels each authorizing the transmission with a single node, a data conversion step for the transmission thereof, for example in series, and the computer of each of the nodes responds to the reception of a message by an unconditional transmission that propagates the data streams along closed chains, the control of data streams then being implicitly determined by the cabled topology used, and the transmission between nodes uses an asynchronous or isochronous mode.

While basing itself on the use of such a network in which functional nodes are connected in series by data transmission means, the invention seeks to optimize a certain number of features of those networks, for example their reliability, their throughput, the handling of failure modes, etc.

### SUMMARY OF THE INVENTION

It is an object of the present invention to provide a data transmission network, of the type including functional nodes connected in series by data transmission means, in which the data assumes the form of discrete messages propagating from node to node in the network, characterized in that:

the means for transmitting data between the nodes are bidirectional to allow data to propagate in both circulation directions of the network,

each node includes at least one first and one second port associated by programming, for data input/output, connected to adjacent nodes by corresponding data transmission means and the operation of which is controlled exclusively and sequentially, by communication automaton means, between an operating mode for the asynchronous reception of data from the adjacent nodes, and an operating mode for the synchronous transmission of data to the nodes adjacent thereto.

According to other features of the network according to the invention considered alone or in combination:

the communication automaton is suitable for switching the ports associated with the node from their reception operating mode to their transmission operating mode, after, for each of them:

either the reception of valid data,

or the expiration of a predetermined length of time for the non-reception of valid data.

The communication automaton is suitable for switching each of the associated ports, in return, from its transmission operating mode to its reception operating mode, after the end of transmission of data by the port.

The ports associated with each node are connected to first in-first out logic buffer means.

Nodes include more than two associated input/output ports.

The nodes are connected in a closed loop by data transmission means.

The nodes are connected by data transmission means, in at least one branch whereof the end nodes are suitable for operating in mirror mode for returning data to the adjacent transmitting node.

The nodes are connected by data transmission means, in a connecting branch with other nodes connected in a closed loop by data transmission means.

Each node is suitable for switching into mirror operating mode for returning data to an adjacent transmitting node if a malfunction is detected.

At least some nodes include means for generating service data intended to be transmitted on the network.

At least some nodes include means for generating error data intended to be transmitted if valid data is not received from an adjacent node within a predetermined length of time.

The data transmission means include wired connecting means.

The data transmission means include pairs of twisted wires.

The data transmission means include coaxial cables.

The data transmission means include optical fibers.

The data transmission means include wireless connecting means.

The ports associated with the node by programming are associated [with] the communication automaton means by programming

The communication automaton means receive programming data for the association of ports, via a channel outside the network.

The communication automaton means receive programming data for the association of ports, via the network directly.

The communication automaton means receive programming data for the association of the ports, from local storage means thereof.

According to another aspect, the invention also relates to a corresponding network node.

### BRIEF DESCRIPTION OF THE DRAWINGS

The invention will be better understood using the following description, provided solely as an example and done in reference to the appended drawings, in which:

FIG. 1 shows a block diagram illustrating the general structure of functional nodes connected in series in a data transmission network according to the invention,

FIG. 2 shows a block diagram illustrating the general structure of an example embodiment of a node included in the composition of a transmission network according to the invention,

FIGS. 3 and 4 illustrate the general operating principle of a data transmission network according to the invention,

FIG. 5 illustrates the switching of the operation of a node between its reception mode and its transmission mode,

FIG. 6 provides a detailed illustration of a register structure included in the composition of a node,

FIG. 7 illustrates the normal operation of a node included in the composition of a network according to the invention,

FIG. 8 shows a downgraded operating mode of the transmission network according to the invention,

FIG. 9 illustrates the structure of a node including more than two data input and output ports,

FIG. 10 illustrates an example embodiment of a network formed from nodes, and

FIG. 11 illustrates an example embodiment of a message frame format used in a transmission network according to the invention.

### DETAILED DESCRIPTION

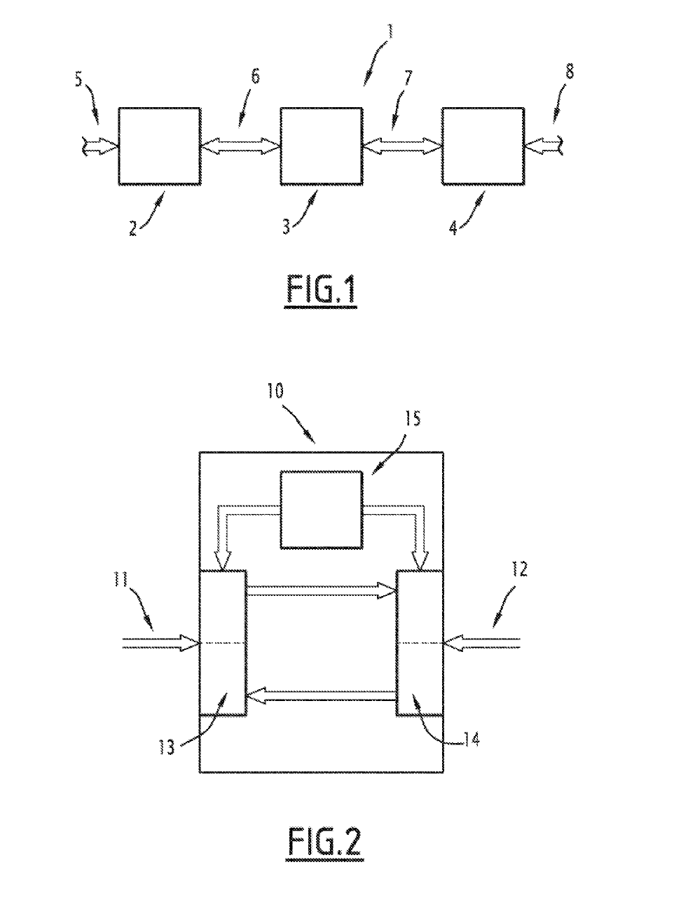

FIG. 1 in fact illustrates an example embodiment of a portion of a data transmission network that includes functional nodes connected in series by data transmission means.

In this FIG. 1, the network is designated by general reference 1 and, in the described example, includes three nodes designated by references 2, 3 and 4, respectively.

These functional nodes are therefore connected in series by data transmission means for example designated by references 5, 6, 7 and 8, respectively.

These data transmission means can be based on wired transmission means for example formed by pairs of twisted wires or coaxial or other cables.

However, other embodiments may be considered, for example the use of optical fibers, or others, as well as wireless connecting means, for example acoustic.

This network is then suitable for transmitting data that assumes the form of discrete messages propagating from node to node in the network.

In the transmission network according to the invention, the data transmission means between the nodes are bidirectional to allow data to propagate in both circulation directions of the network.

Such an operation is for example illustrated in FIGS. 2, 3 and 4.

FIG. 2 shows an example embodiment of a node included in the composition of such a network, that node being designated by general reference 10.

That node is then for example connected by means of two data transmission means 11 and 12, respectively, to adjacent nodes in the network.

In fact, each node includes at least one first and one second associated port for the input/output of data, for example designated by general references 13 and 14 in this FIG. 2, connected by the corresponding data transmission means 11 and 12, respectively, to the adjacent nodes in the network. The operation of these associated data input/output ports is then controlled sequentially and exclusively, via communication automaton means designated by general reference 15, between an operating mode for the asynchronous reception of data from the adjacent nodes and an operating mode for the synchronous transmission of data to the neighboring nodes.

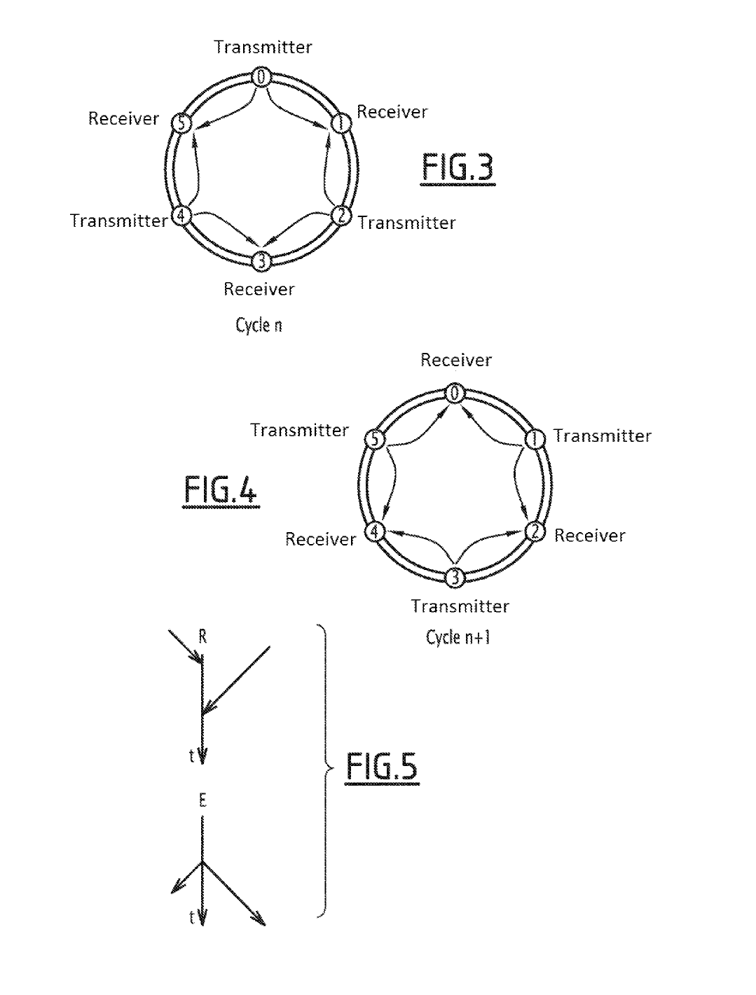

One can thus see that, related to a network like that illustrated in FIGS. 3 and 4, in which the nodes are for example connected in a closed loop, each node switches exclusively and sequentially, between an operation transmitting data to its adjacent nodes, which are then in the reception operating mode, and an operation receiving data from its neighbors, which are then in the transmission operating mode.

FIGS. 3 and 4 in fact illustrate two successive cycles n and n+1, allowing the nodes to transmit the data in the network.

In fact, and as illustrated by FIG. 5, for each node, the switching between the reception mode R and the transmission mode E is activated by the communication automaton once the corresponding node has received data from its neighbors. The expression “operating mode for the asynchronous reception of data from its adjacent nodes” is used in this sense.

Once data is received from its neighbors, the communication automaton then switches the corresponding associated ports of the node to their transmission operating mode, all of the ports associated with the node then going into the mode for the transmission of data to the adjacent nodes. The expression “operating mode for the synchronous transmission of data to the adjacent nodes” is used in this sense.

In fact, the communication automaton is suitable for switching all of the ports associated with the node from their reception operating mode to their transmission operating mode after, for each of them, either the reception of valid data, or the expiration of a predetermined length of time for the non-reception of valid data.

In the other direction, the communication automaton is suitable in return for switching each of the associated ports from its transmission operating mode E to its reception operating mode R, after the end of transmission of the data by the port.

One can then see that this makes it possible to avoid any collision of messages on the data transmission means, inasmuch as adjacent nodes cannot transmit at the same time on the data transmission means connecting them to one another.

As indicated in the aforementioned prior document, this makes it possible to avoid the use, in the nodes, of extremely heavy means for managing collisions on the network, which results in a very significant simplification thereof.

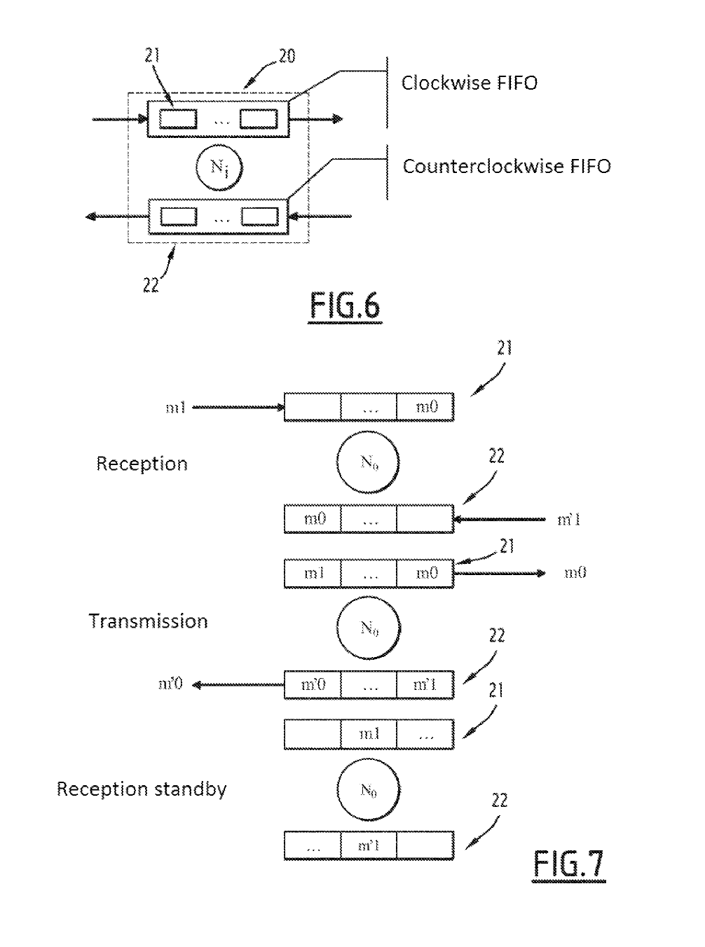

One example embodiment of such a node is illustrated in FIG. 6.

In fact, the node illustrated in that figure is designated by general reference 20, and the ports associated therewith for example comprise means in the form of “First In-First Out” (FIFO) registers, mounted head-to-tail between the data transmission means connecting that node to its neighbors.

Of course, any other structure using first-in-first-out logic buffer means can also be used.

These FIFO register means are designated by general references 21 and 22.

One of these means then makes it possible to transmit the data in one direction and the other in the other direction of the network. These register means in fact receive data coming from a node to transmit it by propagating it to the other adjacent node, and vice versa.

The operation of such a node is illustrated in FIG. 7.

This figure in fact shows the registers 21 and 22 previously described in their different states based on the state of the node under the control of the communication automaton.

The first state illustrated in the top part of this figure is the state of the node for the reception of data.

Each FIFO register means 21, 22 already has, in memory, a message previously received and designated by m0 and m′0 for the messages circulating in either direction of that network.

In the state illustrated in the upper part of the figure, the node is in the operating mode for receiving subsequent messages, for example messages m1 and m′ 1.

Once the two messages m1 and m′l have been received, the node, as previously described, goes under the control of the communication automaton, in the mode for transmitting preceding messages, i.e., m0 and m′0, which are then transmitted to the corresponding adjacent nodes.

This state is illustrated in the middle part of FIG. 7.

In the bottom part of this FIG. 7, the messages m0 and m′0 have been transmitted such that the node then enters standby while awaiting the reception of messages from its neighbors, and so forth.

One can then see that the messages are placed in a queue and are transmitted once new messages are received.

As previously indicated, in the nominal operating case of this network, i.e., when all of the nodes and all of the data transmission means are operational, the network then allows a complete circulation of data in both circulation directions of the messages on the network.

Thus for example, and in the case where the network is made up of nodes connected in a closed loop, the network can then be likened to two logic rings in which messages circulate.

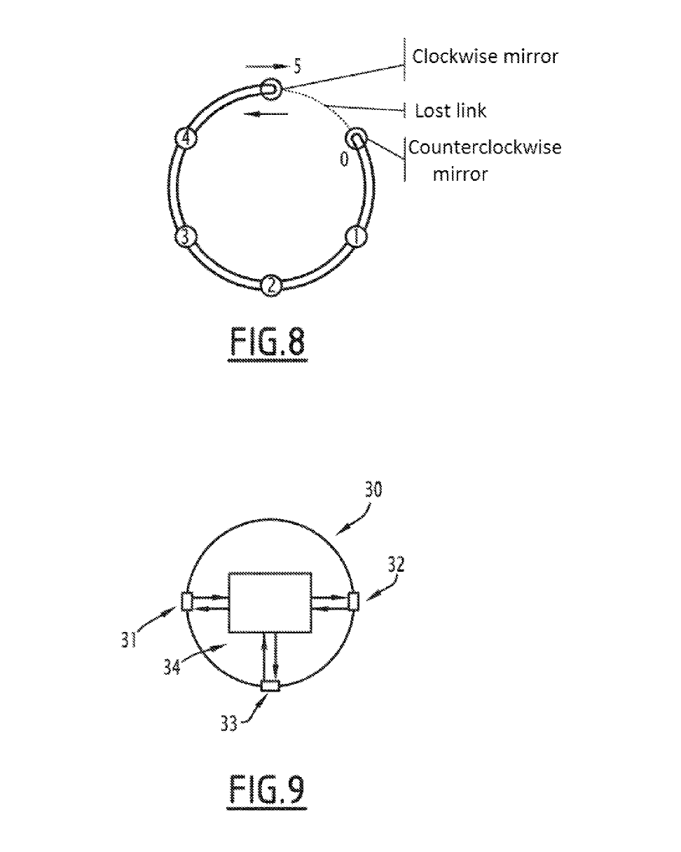

If one of the data transmission means is lost between two adjacent nodes, as illustrated in FIG. 8, the communication topology is modified to restore a single ring.

In that case, the end nodes of the branch thus formed are suitable for operating in mirror mode returning data to be transmitted to the adjacent node.

This is then done by controlling the corresponding ports of those nodes using the corresponding communication automaton means. These automaton means then detect that malfunction and command switching of the ports into minor mode.

As previously indicated, nodes of the network may also include more than two associated input/output ports, like that illustrated in FIG. 9.

The node shown in this figure, and designated by general reference 30, then for example includes three or more associated ports designated by references 31, 32 and 33, optionally associated with data routing means 34.

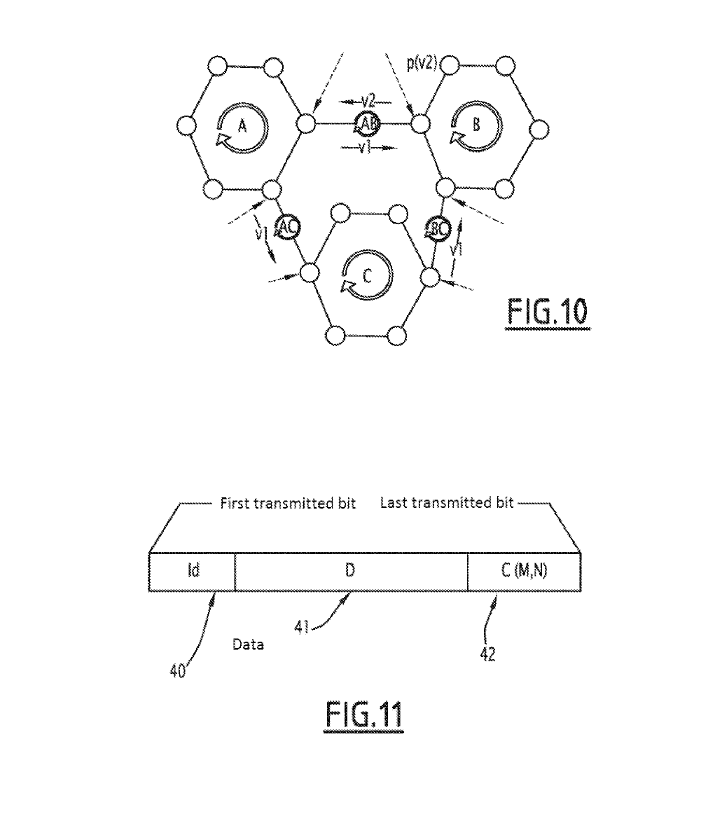

This then makes it possible to multiply the number of possible network configurations with such nodes, as illustrated in FIG. 10, where one can see that nodes may be connected in a closed loop by corresponding data transmission means.

Furthermore, nodes may also be connected by data transmission means in at least one branch whereof the end nodes are suitable for operating in their mode returning data to the transmitting adjacent node, or in connecting branches of other nodes connected in a closed loop by data transmission means.

Of course, other configurations may also be considered.

Lastly, FIG. 11 shows one possible example embodiment of a message format, that format traditionally including a message header 40, data 41 and a control portion designated by general reference 42.

To that end, it may be noted that at least some nodes may also include means for generating error data intended to be transmitted in case of non-reception of valid data from a neighboring node in a predetermined length of time.

Likewise, at least some of these nodes may also include, traditionally in this type of application, means for generating service data intended to be transmitted on the network.

Several other features of the data transmission network and implemented means may be noted. Thus:

The data transmission means may include a serial or parallel connection between the nodes.

The data transmission means may include a half or full duplex physical support between the nodes, i.e., using a same support in both data circulation directions on the network or one support per direction, respectively.

The data transmission means may choose a physical layer chosen from the group comprising: a RS422, RS 485, Flexray, LIN, CAN, ARINC429, BD 429, ARINC629, Safebus, Ethernet, ARINC859, ATM, MIL-STD-1553, Digibus, ASCB, Spacewire, SCI, SPI, I2C, PCI, PClexpress, Fibre Channel, Firewire, USB and FDDI network.

The data transmission means may use message formats chosen from the group comprising the following frame formats: Flexray, LIN, CAN, TTP, ARINC429, ARINC629, Safebus, Ethernet, ATM, MIL-STD-1553, Digibus, ASCB, Spacewire, SCI, I2C, PCI, PCIexpress, Fibre Channel, Firewire, USB and FDDI.

Said ports associated with the node are for example associated by the communication automaton means. These communication automaton means then receive corresponding programming data for the association of ports, for example by the network directly, by an external channel separate and/or independent from that network, or from local storage means thereof, for example integrated into the communication automaton means or more generally, the corresponding node (FPGA bitstream, etc.).

Of course, still other embodiments may be considered.

What is claimed is:

1-21. (canceled)

22. A data transmission network comprising:
functional nodes connected in series by at least one data transmitter, the data assuming the form of discrete messages propagating from node to node in the network;
the at least one transmitter for transmitting data between the nodes being bidirectional to allow data to propagate in both circulation directions of the network,
each node including at least one first and one second port associated by programming, for data input/output, connected to adjacent nodes by a corresponding data transmitter of the at least one transmitter and the operation of each node is controlled exclusively and sequentially, by a communication automaton, between an operating mode for the asynchronous reception of data from the adjacent nodes, and an operating mode for the synchronous transmission of data to the nodes adjacent thereto.

23. The data transmission network as recited in claim 22 wherein the communication automaton is suitable for switching the first and second ports associated with the node from the reception operating mode to the transmission operating mode, after, for each of the ports:
either the reception of valid data,
or the expiration of a predetermined length of time for the non-reception of valid data.

24. The data transmission network as recited in claim 23 wherein the communication automaton is suitable for switching each of the associated first and second ports, in return, from the transmission operating mode to the reception operating mode, after the end of transmission of data by the associated first or second port.

25. The data transmission network as recited in claim 22 wherein the first and second ports associated with each node are connected to a first in-first out logic buffer.

26. The data transmission network as recited in claim 22 wherein the nodes include at least one further associated input/output port in addition to the first and second ports.

27. The data transmission network as recited in claim 22 wherein the nodes are connected in a closed loop by the at least one data transmitter.

28. The data transmission network as recited in claim 22 wherein the nodes are connected by the at least one data transmitter, in at least one branch whereof end nodes of the nodes are suitable for operating in minor mode for returning data to the adjacent transmitting node.

29. The data transmission network as recited in claim 22 wherein the nodes are connected by the at least one data transmitter, in a connecting branch with other nodes connected in a closed loop by the at least one data transmitter.

30. The data transmission network as recited in claim 22 wherein each node is suitable for switching into minor operating mode for returning data to an adjacent transmitting node if a malfunction is detected.

31. The data transmission network as recited in claim 22 wherein at least some nodes include a generator for generating service data intended to be transmitted on the network.

32. The data transmission network as recited in claim 22 wherein at least some nodes include a generator for generating error data intended to be transmitted if valid data is not received from an adjacent node within a predetermined length of time.

33. The data transmission network as recited in claim 22 wherein the data transmitter includes a wired connector.

34. The data transmission network as recited in claim 33 wherein the data transmitter includes pairs of twisted wires.

35. The data transmission network as recited in claim 33 wherein the data transmitter include coaxial cables.

36. The data transmission network as recited in claim 22 wherein the data transmitter includes optical fibers.

37. The data transmission network as recited in claim 22 wherein the data transmitter includes a wireless connector.

38. The data transmission network as recited in claim 22 wherein the first and second ports associated with the node by programming are associated with the communication automaton.

39. The data transmission network as recited in claim 38 wherein the communication automaton receives programming data for the association of the first and second ports, via a channel outside the network.

40. The data transmission network as recited in claim 38 wherein the communication automaton receives programming data for the association of the first and second ports, via the network directly.

41. The data transmission network as recited in claim 38 wherein the communication automaton receives programming data for the association of the first and second ports, from a local storage thereof.

42. A data transmission network node designed for the data transmission network as recited in claim 22.
